(19) United States
(12) Patent Application Publication
(10) Pub. No.: US 2006/0041834 A1
(43) Pub. Date: Feb. 23, 2006

(54) User-controlled web browser table sorting

(75) Inventors: Yen-Fu Chen, Austin, TX (US); John Hans Handy-Bosma, Cedar Park, TX (US); Keith Raymond Walker, Austin, TX (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/922,244

(22) Filed: Aug. 19, 2004

(51) Int. Cl. G06F 17/24; G06F 17/21

(52) U.S. Cl. 715/509; 715/513; 715/530

(57) ABSTRACT

The invention that meets the needs identified above is a web browser plug-in or feature comprising a modification program (MP), a configuration program (CP), a sorting program (SP), algorithms and rules, that interacts with a web browser to analyze a web page for tables, and to insert controls. The analysis consists of interrogating incoming hypertext markup language (HTML) for table structure <table>, <tr>, <th> and <td> tags, and incoming text for delimiters. The configuration program introduces controls into the text for each column and row delimeter that met a criteria for being sortable. In addition, the configuration program introduces controls into the HTML for each column and row tag that met a criteria for being sortable. The configuration program links the controls to a sorting algorithm so that when activated, the appropriate sorting algorithm will act on the row or column associated with the control. The controls are injected before the web browser renders the web page. When the web browser renders the web page, the web browser recognizes and interprets the injected HTML code so that the table may be sorted by the sorting program.

### CROSS-REFERENCE TO RELATED APPLICATION

The present invention is related to the subject matter of U.S. patent application Ser. No. ______ (Attorney Docket number AUS920040263US1), incorporated herein by reference.

### FIELD OF THE INVENTION

This invention relates generally to computer implemented data processing in general, and more particularly, to a program for sorting columns and rows on a web page.

### BACKGROUND OF THE INVENTION

Digital information displayed on the Internet may be found on web pages viewed through a web browser. A web page is an HTML file containing both text and a set of hyper-text markup language (HTML) tags that describe how the text should be formatted when the web browser displays the web page on a user's display screen. A web browser is a computer program that goes to a web server on the Internet, requests the web page, and retrieves the page so that a user can view HTML documents and access files and programs related to those HTML documents. A web server is a program that uses HTTP to provide HTML documents and files and programs related to those documents when requested by a web browser. The web browser then interprets the HTML tags within the page and displays the page.

The HTML tags direct the browser as to how the web page should look when it is displayed. The browser interprets these tags to determine the format of the text on the screen. The tags can instruct the browser to change fonts, color, and arrange text in tables. Currently, one of the most widely used HTML tools for arranged web pages is a table. Tables are created with the tag, <table>. A horizontal row in a table begins with the tag <tr>, and each piece of data within the horizontal row begins with the tag <td> and <th>. The width of rows and columns, the height of rows and columns, the heading spacing, and the cell spacing in a table can be controlled.

When using a table in a web page, situations arise when a user desires to sort a column or row in a table. For example, a table on a web page may display a comparison of computer manufacturers, models, prices, ratings, central processing unit (CPU), random access memory (RAM), disk space, optical drive specifications, a link to additional information, software installed, warranty, and other details. In the above example, the developer may make the price and ratings columns sortable. A person shopping for computers on the Internet may access and view the table. However, the price and ratings columns are the only sortable columns in the display. If the person accessing the web while shopping for a computer is interested in performance, the person may desire to sort by rating, or by CPU, or by RAM. Additionally, the person may desire to sort first by rating, then by CPU, and then by RAM. Such enhanced sorting would be desireable, but unavailable.

Presently, such enhanced sorting may be obtained in two ways. First, a developer may provide dynamic column sorting and allow the user to set preferences for all columns. Second, the user may copy the web page, paste it into a spreadsheet capable of receiving HTML such as Microsoft Excel, and apply the more advanced sorting capabilities of the spreadsheet. The first solution is not practical because developing dynamic content requires tracking and understanding users and their preferences. Storing user preferences is costly to develop and maintain. The second solution is time consuming, requires a secondary application, requires toggling between applications, and as a practical matter is beyond the capabilities of many users.

Therefore, what is needed is a system that functions through a browser or browser plug-in that empowers a user to sort table columns on any web page, regardless of the coder's implementation.

These and other objects of the invention will be apparent to those skilled in the art from the following detailed description of a preferred embodiment of the invention.

### SUMMARY OF THE INVENTION

The invention that meets the needs identified above is a web browser plug-in or feature comprising a modification program (MP), a configuration program (CP), a sorting program (SP), algorithms and rules, that interacts with a web browser to analyze a web page for tables and insert controls. The analysis consists of interrogating incoming hypertext markup language (HTML) for table structure <table>, <tr>, <th> and <td> tags, and incoming text for delimiters. The analysis further consists of marking all <th>, <td>, and <tr> tags as potentially sortable, and all delimiters for table columns or rows as potentially sortable. The analysis concludes by determining whether the marked tags and/or marked delimeters meet a criteria for being sortable. Next, the configuration program introduces controls into the text for each column and row delimeter that meets the criteria for being sortable. In addition, the configuration program introduces controls into the HTML for each column and row tag that met the criteria for being sortable. The configuration program links the controls to a sorting algorithm so that when activated, the appropriate sorting algorithm will act on the row or column associated with the control. The controls are injected before the web browser renders the web page. When the web browser renders the web page, the web browser recognizes and interprets the injected HTML code so that the table may be sorted by the sorting program.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating one embodiment of the internal configuration of a computer.

FIG. 2 illustrates an architecture for connecting various hardware devices to create a network for transferring data.

FIG. 3 is a flowchart of the Modification Program (MP).

FIG. 4 is a flowchart of the Sorting Program (SP).

FIG. 5 is a flowchart of the Configuration Program (CP).

### DETAILED DESCRIPTION OF THE PREFERRED EMBODIMENT

A person of ordinary skill in the art will appreciate that the present invention may be implemented in a variety of software and hardware configurations. It is believed, however, that the invention is described best as a computer program that configures and enables one or more general-purpose computers to implement the novel aspects of the invention.

As used herein, “computer” means a machine having a processor, a memory, and an operating system, capable of interaction with a user or other computer, and shall include without limitation desktop computers, notebook computers, tablet computers, personal digital assistants (PDAs), servers, handheld computers, and similar devices.

As used herein, “control” means an object on a screen that, when activated by a user, performs an action.

As used herein, “delimeter” means a character used to indicate the beginning and end of a charcter string.

As used herein, “screen” means a user display device upon which a page may be displayed.

As used herein, “tag” means a code identifying an element in a document so that information in the document may be formatted, indexed and linked

As used herein “web browser” means a program that enables a user to access a web page or other HTML document, file, and program related to the web page or other HTML document.

As used herein, “web page” means a Hypertext Markup Language (HTML) file including graphics and/or script in a unique directory identifiable by a uniform resource locator.

As used herein, “wizard” means a utility within an application that interacts with a user in order to guide the user through completion of each step of a task.

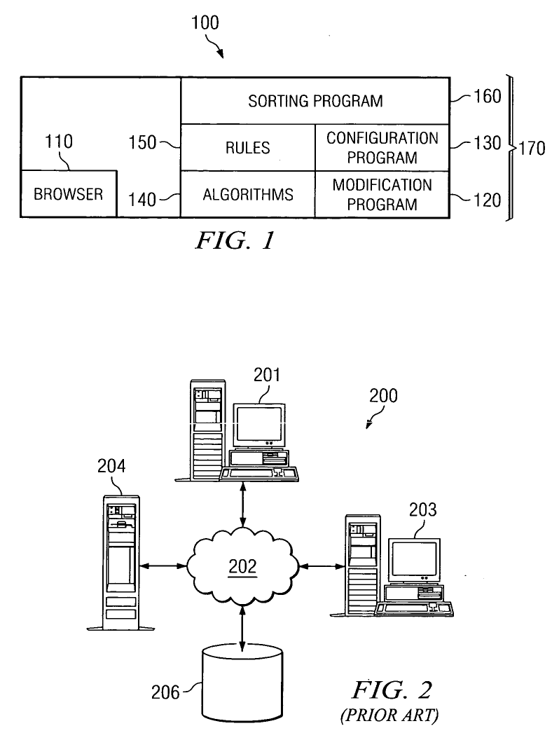

The internal configuration of a computer, including connection and orientation of the processor, memory, and input/output devices, is well known in the art. FIG. 1 represents the internal configuration of a computer having the computer program of the present invention loaded into memory 100. The computer program of the present invention is depicted as modification program (MP) 120, configuration program (CP) 130, sorting program (SP) 160, algorithms 140 and rules 150. Memory 100 also contains browser 110. Memory 100 is only illustrative of memory within a computer and is not meant as a limitation.

The computer is connected to one or more input devices and a display, a user can selectively view the data that is managed by modification program (MP) 120, configuration program (CP) 130, sorting program (SP) 160, algorithms 140 and rules 150. The input device may be a keyboard, mouse, rollerball, tackpad, pen, touch screen and stylus, or voice recognition system. The input device may also be a touch screen associated with the display. Together these elements may be embodied as a variety of computing devices such as a personal digital assistant, cellular telephone, notebook computer, and so forth. In alternative embodiments, modification program (MP) 120, configuration program (CP) 130, sorting program (SP) 160, algorithms 140 and rules 150 and their components can be stored in the memory of other computers.

FIG. 2 illustrates a common prior art architecture for connecting various hardware devices to create a network for transferring data. Computer network 200 comprises local workstation 201 electrically coupled to network connection 202. In FIG. 2, local workstation 201 is coupled electrically to remote workstation 203 via network connection 202. Local workstation 201 also is coupled electrically to server 204 and persistent storage 206 via network connection 202. Network connection 202 may be a simple local area network (LAN) or may be a larger wide area network (WAN), such as the Internet. While computer network 200 depicted in FIG. 2 is intended to represent a possible network architecture, it is not intended to represent an architectural limitation.

Modification program (MP) 120, configuration program (CP) 130, sorting program (SP) 160, algorithms 140 and rules 150 described herein can be stored within memory 100 of any workstation or server depicted in FIG. 2. Alternatively, modification program (MP) 120, configuration program (CP) 130, sorting program (SP) 160, algorithms 140 and rules 150 can be stored in an external storage device such as persistent storage 206, or a removable disk such as a CD-ROM (not pictured). Additionally, browser 110 is generally loaded into the memory of more than one computer of FIG. 2 to enable users on different computers to exchange messages over network connection 202.

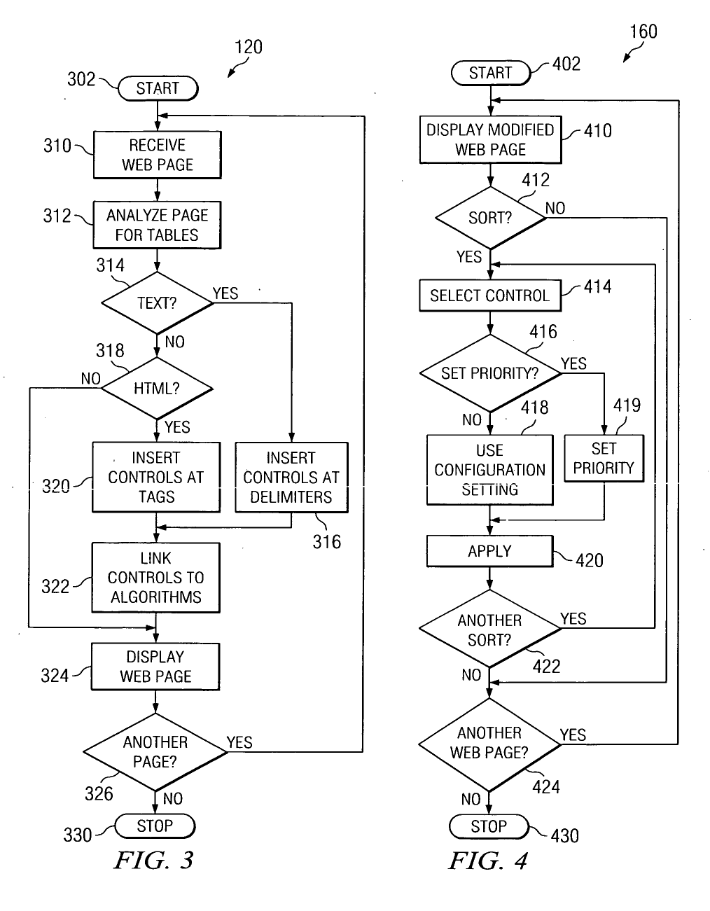

FIG. 3 illustrates a flowchart of Modification Program (MP) 120. MP 120 begins and receives a web page (310). MP 120 analyzes the web page code looking for tables (312). The analysis consists of interrogating incoming hypertext markup language (HTML) for table structure <table>, <tr>, <th> and <td> tags, and incoming text for delimiters. The analysis further consists of marking all <th>, <td>, and <tr> tags as potentially sortable, and all delimiters for table columns or rows as potentially sortable. The analysis concludes by determining whether the marked tags and/or marked delimeters meet a preestablished criteria for being sortable. If MP 120 finds code indicating a table, then MP 120 determines whether the code represents text (314). If the code represents text, MP 120 inserts controls at the delimeters according to rules 150 (316) and MP 120 goes to step 322. If the code does not represent text, MP 120 determines whether the code is HTML (318). If the code is not HTML, MP 120 goes to step 324. If the code is HTML, MP 120 inserts controls at the table tags according to rules 150 (320). The controls that have been inserted in the web page, whether in text or in HTML, are then linked to corresponding algorithms pursuant to configuration program 130 (See FIG. 4) 322. MP 120 displays the web page (324). MP 120 determines whether there is another web page (326). If so, MP 120 goes to step 310. If not, MP 120 ends (330). The controls are injected before the web browser renders the web page. When the web browser renders the web page, the web browser recognizes and interprets the injected HTML code so that the table may be sorted by the sorting program.

FIG. 4 is a flow chart of sorting program (SP) 160. SP 160 begins (402) and displays the modified web page (410) (see 324, FIG. 3). SP 160 determines whether the user wants to perform a sort operation (412). If the user does not want to peform a sort operation, SP 160 goes to step 424. If the user wants to perform a sort operation, the user is prompted to select a control (414). SP 160 determines whether the user wants to set a priority (416). If the user wants to select a priority, the user is prompted to make the selection to set the priority (419) and the selection is applied (420).

The priority selected by the user establishes an order of precedence for sorts. For example, the first column sorted may establish the lowest precedence. Tables 1 through 3 depict such a priority. Table 1 depicts a two column table.

TABLE 1

| | |
|---|---|
| 2 | A |
| 1 | B |
| 2 | C |
| 1 | E |
| 2 | D |

If the user selects the second column of Table 1 for sorting, and applies SP 160, SP 160 reorders the data in the columns reorders as shown in Table 2.

TABLE 2

| | |
|---|---|
| 2 | A |
| 1 | B |
| 2 | C |
| 2 | D |
| 1 | E |

If the user selects the first column of Table 2 for sorting and applies SP 160, the second column maintains its order of A through E, but is filtered by the numbers in the first column and sorted as shown in Table 3

TABLE 3

| | |
|---|---|
| 1 | B |
| 1 | E |
| 2 | A |
| 2 | C |
| 2 | D |

If the user does not want to select a priority, SP 160 uses the configuration setting (418) and applies the configuration setting (420). A determination is made whether the user wants to perform another sort operation (422). If the user wants to perform another sort operation, SP 160 goes to step 414. If not, SP 160 determines whether there is another web page to display (424). If there is another web page to display, SP 160 goes to step 410. If not, SP 160 stops (430).

Persons skilled in the art will be aware that the sorting SP 160 for columns applies to rows when the table layout arranges categories and/or headers vertically rather than horizontally.

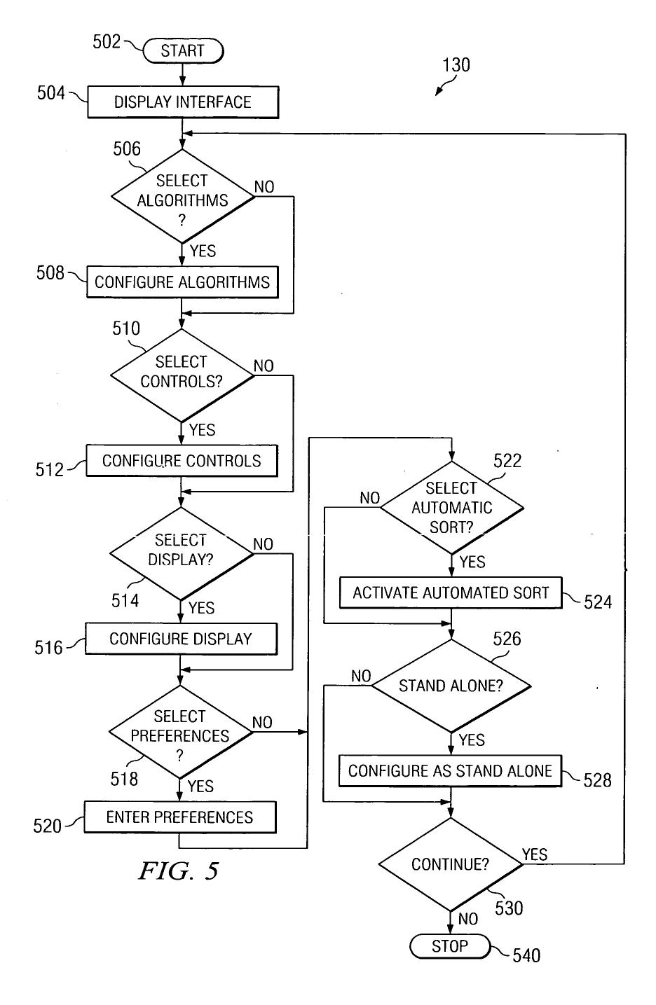

FIG. 5 is a flowchart of Configuration Program (CP) 130. CP 130 begins (502) and displays the user interface (504). CP 130 determines whether the user wants to select algorithms (506). If the user wants to select algorithms, then the user selects from available options. For example, one algorithm may load the sortable data (determined by MP 120) into a Java String array so that sorting will be on the header fields in the array list. Another algorithm may translate the table data into an extensible markup language (XML) format so that an XML parser can be applied to sort the data. Another algorithm may translate the table data into an extensible style sheet language (XSL) so that an XSL parser can be applied to sort the data. Yet another algorithm may identiy date/time formats such as universal time coordinate (UTC), XML, or database timestamp, and sorts the data/time formats chronologically.

CP 130 determines whether the user selects controls (510). If so, CP 130 prompts the user to configure the controls (512). The user may configure the manner in which a particular sort parameter is selected by choosing an icon displayed at a column or row, or by choosing sort parameters available from a control panel. The user may configure the manner in which a particular sort parameter is selected by choosing a verbal description such as “sort column ascending or sort column descending.” The user may choose to save settings between sessions or pages by maintaining the same page by configuring a “remember page options” setting. For example, the user may configure the manner in which the user would select sorting by choosing from an item in the context menu, in the browser's regular menu, in a dedicated toolbar, or in a dedicated control panel.

CP 130 determines whether the user wants to select display (514). If so, CP 130 prompts the user to configure the display (516). For example, the user may configure CP 130 to provide a display within the browser display. Alternatively, the user may configure CP 130 to provide a display in a separate area from the browser display. Additionally, the user may elect to have a small preview display in a separate panel. The preview display presents the isolated data set in table form so that the user can sort the data in different ways and view the dynamically updated data. The user can then enter apply when the preview screen shows the data sorted in a desirable order.

CP 130 determines whether the user wants to select preferences (518). If so, the user is prompted to make selections regarding preferences (520). A wide variety of preferences may be available to the user. The user may choose to apply persistent settings to all pages on the same site. The user may choose to apply predictive heading names where the user typically wants to highlight columns that have a <th> tag or a top row's <td> tag with a certain value. For example, the user may want to highlight the column containing prices with the heading “Price.” Moreover, the user could include a word, such as price, in a list that will automatically sort the column should the word appear on any site. The user could choose to allow a number of contiguous rows or cells to be displayed before an option to sort the rows or cells is offered.

The user may configure MP 120 to maintain a copy of the latest sorted dataset in memory so that if the user wants to update at a later time, MP 120 may use the prior table without having to repeat the analysis and insertion of controls. The user may configure MP 120 to provide a preview display so that by activating a preview button, MP 120 will bring up a second window so that a user configurable number of rows with columns may be seen showing what the sorted table will look like. Such a panel may appear in a corner of the display such as the upper left hand corner.

If not, a determination is made as to whether the user wants to select automatic sort (522). If so, the user is prompted to activate automatic sort (524). When automatic sort is activated, all tables will be autamtically sorted in accordance with the user's preferences.

CP 120 determinates whether the user wants to make SP 120 a stand alone application (526). If so, SP 120 is configured as a stand alone application (528). The invention may be configured as a stand alone application by acting as a personal proxy server for all incoming HTML code that passes through MP 120 and which is then modified before sending to the browser. The invention becomes a personal proxy server by setting the browser proxy settings to “localhost (127.0.0.1) with the port of MP 120, such as 8080. Then, when a page is initially requested by the user from the browser, MP 120 receives HTTP headers from the browser on port 8080, sends the request to the web site on port 80, receives the HTML on port 80, examines the HTML, analyzes the HTML, and inserts controls as necessary, and then sends the resulting page to the browser on port 8080. When the user clicks a column or row to sort, the request goes to MP 120 on port 8080. Now, when MP 120 examines the headers they do not include going to a web site, and so all MP 120 has to do is re-examine what it already has in cache, and send the HTML back to the browser.

A determination is made as to whether the user wants to continue (530). If so, CP 130 goes to step 506. If not, CP 130 ends (540). Persons skilled in the art will be aware that a control panel may store user preferences as a global preset.

Persons skilled in the art will realize that algorithms 140 and rules 150 may be expanded in numerous ways to allow various enhanced sorting configurations. For example, one configuration may interpret date and time formats to sort the date and time formats chronologically. Another configuration may ignore characters in a cell in the sort order, so that each cell is interpreted as a numeric. Such a configuration would enable proper sorting of currency and percentages. Another configuration may mark the forward slash as a fraction symbol in a column to allow sorting of fractions. Another configuration may mark the parentheses character to have the meaning that the number between the parentheses is a negative number. Another configuration may interpret numbers using the exponential E+ style. Another configuration may interpret alternate number systems such as hexadecimal so that 0A would be interpreted as a lower number than 10. Another configuration may intepret the power designator and sort based upon the calculation. For example, the user may specify a power designator such as “ˆ,” to the _th power.” Another configuration may specify a value to the graphics used for ratings. Such a configuration would allow the parser to interpret nine contiguous star.gif images as the number 9, and the user to assign an image name of 8half.gif as 8.5. Another configuration may parse various measurement symbols to correctly sort numbers such as 1 MB and 9 Kb. In this configuration, the user may assign a numeric multiplier to the characters when the web page coder used characaters not predicted by the web browser plug-in of the present invention. Another configuration may associate colors to positive or negative, allowing sorting of a column where negatives are marked as red or some other color.

Persons skilled in the art are aware that the web browser plug-in of the present invention may be configured as a stand alone application with a flowing window.

Persons skilled in the art are aware that preferences may be shared by developers and among users to reduce the amount of configuration required by users. For example, a developer may include default configuration specific to popular sites.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A method for sorting data in a table of a web page comprising:
receiving the web page at a computer connected to the Internet;
interrogating incoming hypertext markup languge in the web page for a table structure tag;
responsive to finding a table structure tag, marking the table structure tag as a potentially sortable tag;
determining whether the potentially sortable tag meets a criteria for sorting;
responsive to determining that the potentially sortable tag meets the criteria, introducing a control into the potentially sortable tag to create a sortable tag;
linking the control to a sorting alogorithm; and
activating the control so that the data associated with the table structure tag is sorted.

2. The method of claim 1 further comprising:
setting a priority for sort precedence.

3. The method of claim 1 further comprising:
selecting an algorithm.

4. The method of claim 3 wherein the selected algorithm loads a plurality of sortable data into a Java String array so that a plurality of header fields in an array list will be sorted.

5. The method of claim 3 wherein the selected algrorithm translates a pluraltiy of table data into an extensible markup language (XML) format so that an XML parser or extensible style sheet language (XSL) can be applied to sort the data.

6. The method of claim 3 wherein the selected algorithm identifies a format providing date and time and sorts the data chronologically.

7. The method of claim 6 wherein the format is universal time coordinate.

8. The method of claim 6 wherein the format is extensible markup language XML.

9. The method of claim 1 further comprising:
providing a separate display within a browser display.

10. The method of claim 1 further comprising:
providing a display in an area separate from a browser display.

11. The method of claim 1 further comprising:
providing a preview display in a separate panel showing dynamically updated data.

12. The method of claim 11 wherein a sort is applied when the preview display shows data sorted in a desirable order.

13. The method of claim 1 wherein the user selects sorting from a context menu.

14. The method of claim 1 wherein the user selects sorting from a dedicated toolbar.

15. The method of claim 1 wherein the user selects sorting from a dedicated control panel.

16. The method of claim of claim 15 wherein the dedicated control panel is stored as global preset.

17. The method of claim 1 wherein the algorithm is activated by selecting an icon associated with the control.

18. The method of claim 1 wherein the control is activated by selecting “sort column ascending”

19. The method of claim 1 wherein the control is activated by selecting “sort column descending.”

20. The method of claim 1 further comprising:
choosing a “remember page options” setting

21. The method of claim 1 further comprising:
appling a plurality of persistent settings to all web pages.

22. The method of claim 1 further comprising:
applying predictive heading names to highlight a <th> tag or a <td> tag with a certain value.

23. The method of claim 1 wherein the control will be activated if a pre-designated word appears on the web page.

24. The method of claim 1 wherein an option to sort rows cannot be displayed until a pre-designated number of contiguous rows are displayed.

25. The method of claim 1 wherein an option to sort columns cannot be displayed until a predesignated number of contiguous columns are displayed.

26. The method of claim 1 further comprising:
maintaining a copy of the latest sorted dataset in memory.

27. The method of claim 1 further comprising:
providing an automatic sort capability.

28. An apparatus for sorting data in a table of a web page comprising:
a web server connected to the Internet;
a computer connected to the Internet;
a program in the memory of the computer that causes the computer to perform the following steps:
receiving the web page at a computer connected to the Internet;
interrogating incoming hypertext markup languge in the web page for a table structure tag;
responsive to finding a table structure tag, marking the table structure tag as a potentially sortable tag;
determining whether the potentially sortable tag meets a criteria for sorting;
responsive to determining that the potentially sortable tag meets the criteria, introducing a control into the potentially sortable tag to create a sortable tag;
linking the control to a sorting alogorithm; and
activating the control so that the data associated with the table structure tag is sorted.

29. The apparatus of claim 28 further comprising:
configured as a stand alone application.

30. The apparatus of claim 28 further comprising:
setting a priority for sort precedence.

31. The apparatus of claim 28 further comprising:
select an algorithm.

32. The apparatus of claim 28 wherein the selected algorithm loads a plurality of sortable data into a Java String array so that a plurality of header fields in an array list will be sorted.

33. The apparatus of claim 28 wherein the selected algrorithm translates a plurality of table data into an extensible markup language (XML) format so that an XML parser or extensible style sheet language (XSL) can be applied to sort the data.

34 The apparatus of claim 28 wherein the selected algorithm identifies a format providing date and time and sorts the data chronologically.

35. The apparatus of claim 28 wherein the format is universal time coordinate.

36. The apparatus of claim 28 wherein the format is extensible markup language XML.

37. The apparatus of claim 28 further comprising:
providing a separate display within a browser display.

38. The apparatus of claim 28 further comprising:
providing a display in an area separate from a browser display.

39. The apparatus of claim 28 further comprising:
providing a preview display in a separate panel showing dynamically updated data.

40. The apparatus of claim 38 wherein a sort is applied when the preview display shows data sorted in a desirable order.

41. The apparatus of claim 28 wherein the user selects sorting from a context menu.

42. The apparatus of claim 28 wherein the user selects sorting from a dedicated toolbar.

43. The apparatus of claim 28 wherein the user selects sorting from a dedicated control panel.

44. The apparatus of claim of claim 28 wherein the dedicated control panel is stored as global preset.

45. The apparatus of claim 28 wherein the algorithm is activated by selecting a icon associated with the control.

46. The apparatus of claim 28 wherein the control is activated by selecting “sort column ascending”

47. The apparatus of claim 28 wherein the control is activated by selecting “sort column descending.”

48. The apparatus of claim 28 further comprising:
choosing a “remember page options” setting.

49. The apparatus of claim 28 further comprising:
applying a plurality of persistent settings to all web pages.

50. The apparatus of claim 28 further comprising:
applying predictive heading names to highlight a <th> tag or a <td> tag with a certain value.

51. The apparatus of claim 28 wherein the control will be activated if a pre-designated word appears on the web page.

52. The apparatus of claim 28 wherein an option to sort rows cannot be displayed until a pre-designated number of contiguous rows are displayed.

53. The apparatus of claim 28 wherein an option to sort columns cannot be displayed until a predesignated number of contiguous columns are displayed.

54. The method of claim 28 further comprising:
maintaining a copy of the latest sorted dataset in memory.

55. The method of claim 28 further comprising:
providing an automatic sort capability.
